(19) United States
(12) Patent Application Publication
(10) Pub. No.: US 2002/0133794 A1
(43) Pub. Date: Sep. 19, 2002

(54) Method and apparatus for integrated circuit debugging

(76) Inventors: Ruban Kanapathippillai, Dublin, CA (US); Kumar Ganapathy, Palo Alto, CA (US); George Moussa, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/081,331

(22) Filed: Feb. 20, 2002

Related U.S. Application Data
(60) Provisional application No. 60/271,280, filed on Feb. 24, 2001.

(51) Int. Cl. G06F 17/50

(52) U.S. Cl. 716/4

(57) ABSTRACT

Method and apparatus for integrated circuit debugging. Three debug access methods into an integrated circuit are provided to control the testing and debugging of program code, functional blocks and circuitry therein. The debug access includes a serial access, an I/O mapped parallel access, and a direct parallel access. The three debug accesses have varying levels of intrusiveness and test/debug efficiency. Depending upon whether the integrated circuit is unpackaged, packaged, coupled to a printed circuit board or found within a system, any one or more of the three debug accesses to debugging the integrated circuit can be utilized.

### CROSS REFERENCE TO RELATED APPLICATION

This non-provisional U.S. patent application claims the benefit of U.S. Provisional Application No. 60/271,280 filed on Feb. 24, 2001 by inventors George Moussa et al titled “METHOD AND APPARATUS FOR INTEGRATED CIRCUIT DEBUGGING”.

### FIELD OF THE INVENTION

The invention relates generally to the field of integrated circuit testing. Particularly, the invention relates to on-chip debugging of an integrated circuit.

### BACKGROUND OF THE INVENTION

As integrated circuit devices have become more complex, functional testing has become more difficult. Functional blocks and circuitry within integrated circuits are often far removed from the bonding pads or pins of a packaged integrated circuit. This makes direct testing of functional blocks or circuitry difficult. Without the capability to directly test functional blocks or circuitry, it is oftentimes difficult to determine what may be causing a failure in the overall functionality of an integrated circuit. Additionally, the high density of circuitry and semiconductor layers makes it difficult to access test points.

Various well known methods have been employed to directly test functional blocks including providing a serial test port, such as a joint test association group (JTAG) port. In this case, a desired test pattern or test sequence is serially input over the serial test port and the results of the test are serially read out. Using a serial port, reduces the number of dedicated pins needed to provide on-chip debugging of functional blocks and circuitry. However, serial input and output is rather slow. Thus, the testing or debugging sequence of an entire integrated circuit chip using a serial port is rather slow.

### BRIEF DESCRIPTION OF THE DRAWINGS

FIG. 1A is a block diagram of one embodiment of an integrated circuit including an embodiment of the invention and an associated test system with test software.

FIG. 1B is a diagram of a bussing scheme for the test bus, system bus, and debug bus of the integrated circuit of FIG. 1A.

FIG. 1C is a block diagram of another embodiment of an integrated circuit including an embodiment of the invention and an associated test system with test software.

FIG. 1D is a diagram of a bussing scheme for the test bus, system bus, and debug bus of the integrated circuit of FIG. 1C.

FIGS. 2A and 2B are respective block diagrams of one embodiment of a priority encoded multiplexer and a priority encoded demultiplexer corresponding to FIGS. 1A and 1B.

FIGS. 3A and 3B are respective block diagrams of another embodiment of a priority encoded multiplexer and a priority encoded demultiplexer corresponding to FIGS. 1C and 1D.

FIG. 4 is a block diagram of debug registers accessible by an embodiment of the invention.

FIG. 5 is a block diagram of an exemplary embodiment for a serial test port.

FIGS. 6A-6D are block diagrams of exemplary test systems for testing embodiments of the invention.

Like reference numbers and designations in the drawings indicate like elements providing similar functionality.

### DETAILED DESCRIPTION OF THE INVENTION

In the following detailed description of the invention, numerous specific details are set forth in order to provide a thorough understanding of the invention. However, it will be obvious to one skilled in the art that the invention may be practiced without these specific details. In other instances well known methods, procedures, components, and circuits have not been described in detail so as not to unnecessarily obscure aspects of the invention.

A method and apparatus for integrated circuit debugging. In one embodiment, three debug access methods and interfaces into an integrated circuit are provided to control the testing and debugging of the functionality of the integrated circuit including its functional blocks and program code therein. The debug access methods include a serial access by a serial interface, an I/O mapped parallel access by a host parallel interface, and a direct parallel access by a direct parallel interface. These three debug access methods have varying levels of intrusiveness and test/debug efficiency. Depending upon whether the integrated circuit is unpackaged, packaged, coupled to a printed circuit board or found within a system, any one or more of the three debug access methods to debug the integrated circuit can be performed. The type of testing/debugging desired, can also provide motivation to select any one or more of the three debug access methods provided by the integrated circuit.

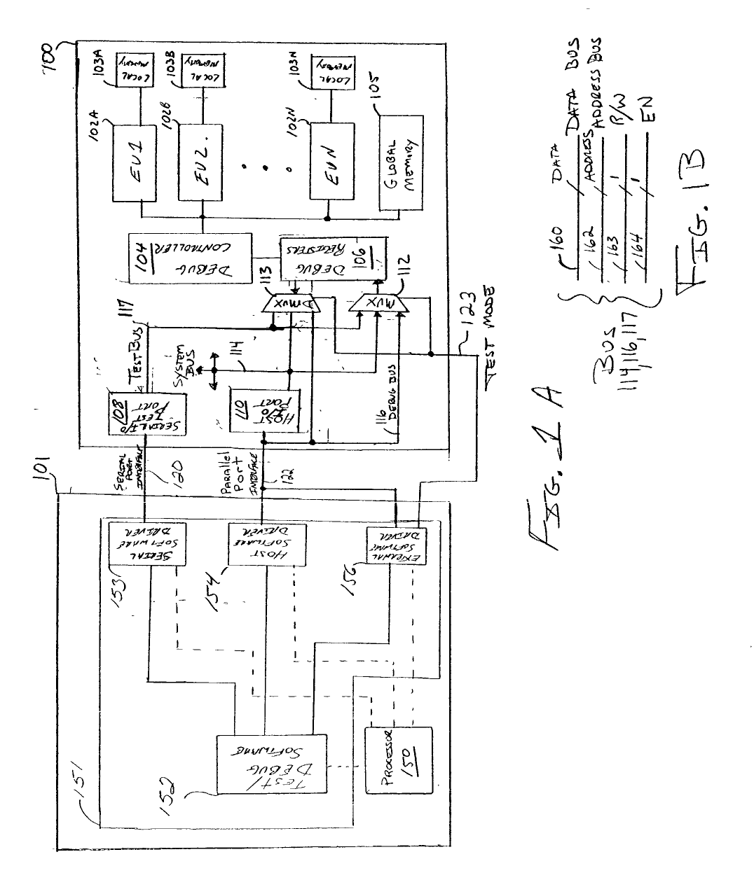

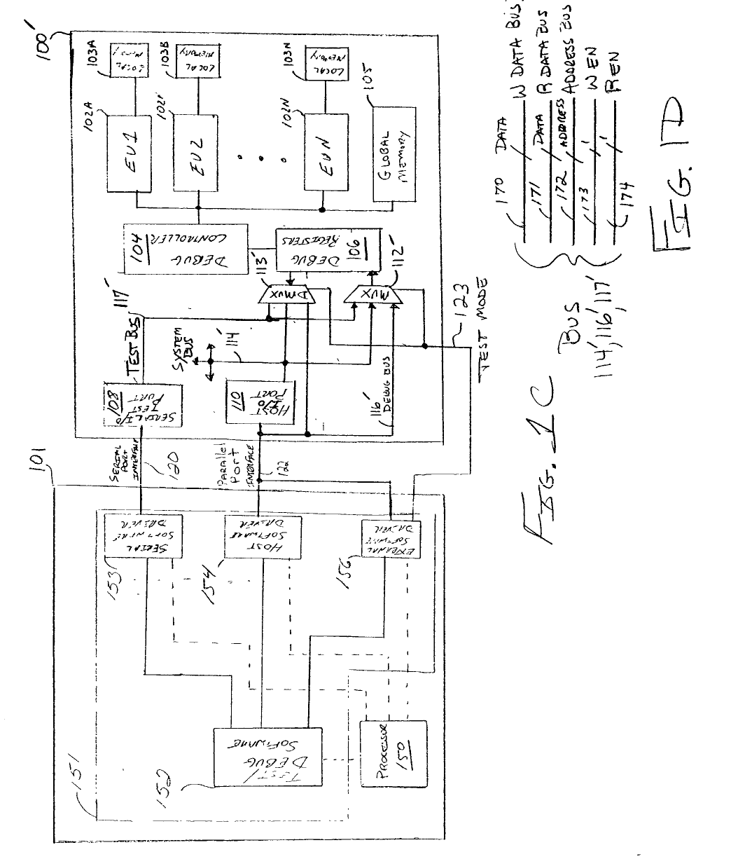

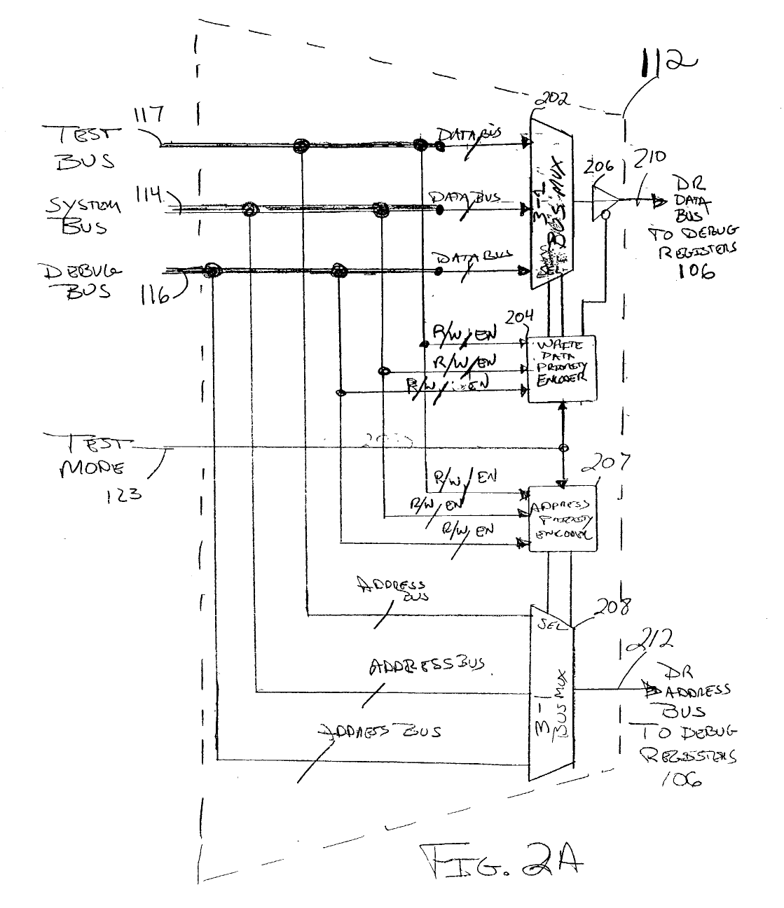

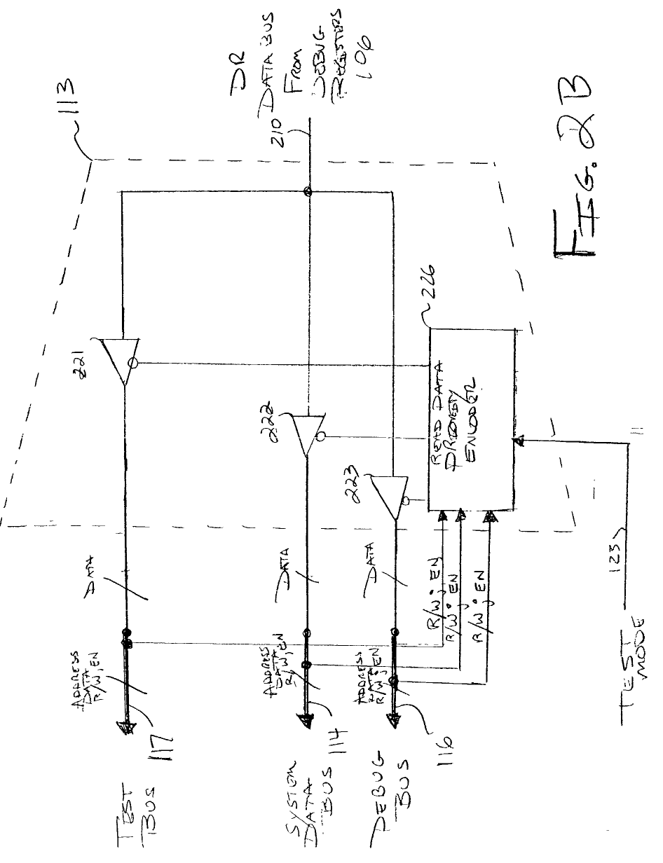

Referring now to FIG. 1A, an integrated circuit 100 including an embodiment of the invention and a tester system 101 are coupled together as illustrated into an integrated circuit test system. The integrated circuit 100 includes one or more execution units EU1-EUN (102A-102N) having one or more respective local memory (103A-103N) coupled thereto, a debug controller 104, a global memory 105, debug registers 106, a serial I/O test port 108, a host I/O port 110, a priority encoded multiplexer 112, and a priority encoded de-multiplexer 113. A serial to parallel converter for the serial input of the serial port interface 120 for converting serial information into parallel information for the debug registers is not shown in FIG. 1A. A parallel to serial converter for the serial output of the serial port interface 120 for converting parallel information from the debug registers 106 into serial information is not shown in FIG. 1A. The invention provides three ways of accessing the on chip debug capability of the integrated circuit 100, including reading and writing information to the debug registers 106, to perform debugging of hardware and software used therein. Certain registers of the debug registers 106 can be set to control the debug controller 104. Registers of the debug registers 106 can also be read and provide results of tests to indicate a pass or a fail or a data value at certain points in the integrated circuit or at certain points in program code being executed in the integrated circuit. The debug controller 104 executes test and debug instructions in response to settings in the debug registers 106 and test instructions or debug commands in order to test and debug the functionality of the integrated circuit. The functionality of the integrated circuit is debugged by debugging the program code stored in the global memory 105 or in the one or more local memory 103A-103N and/or each of the one or more execution units EU1 102A through EUN 102N and their associated circuitry. In one embodiment, the one or more execution units EU1 102A through EUN 102N are one or more digital signal processing units coupled to one or more respective local memory 103A-103N. The debug controller 104 can also be programmed to test and debug other program code and/or functional blocks and circuitry within the integrated circuit 100 through settings of the debug registers 106. The debug controller 104 can be controlled to perform snoops, break of execution of a program, break at an address, reset, single step through instructions, inject instructions, perform memory reads, and download a program. The debug controller 104 can also control built in self tests (BIST) functional blocks within the integrated circuit for testing specific functionality therein. For example, a BIST functional block may be used for testing a memory. Writing to a register in the debug registers 106 may start up a debug process or test sequence within the integrated circuit 100.

Referring now to FIG. 1B, a diagram of the bussing scheme for the test bus 117, the system bus 114, and the debug bus 116 of the integrated circuit 100 of FIG. 1A is illustrated. Each of test bus 117, the system bus 114, and the debug bus 116 includes a data bus 160, an address bus 162, a R/W strobe 163 and an enable strobe 164. The address bus 162 includes A address lines. The data bus 160 includes D data lines. The data bus 160 in this bussing scheme is a tri-statable type of data bus to support bi-direction communication over the D data lines. Each of the test bus 117, the system bus 114, and the debug bus 116 include support and the associated circuitry coupled thereto can support a tri-statable data bus 160.

Referring now to FIG. 1C, a block diagram of another embodiment of an integrated circuit 100′ coupled to an associated test system 101 with test software is illustrated. The integrated circuit 100′ is very similar to the integrated circuit 100 but for its test bus 117′, system bus 114′, and debug bus 116′ and its priority encoded multiplexer 112′ and priority encoded de-multiplexer 113′. The same access is provided to the debug registers 106 in the integrated circuit 100′ but through different means of the test bus 117′, system bus 114′, and the debug bus 116′ and the priority encoded multiplexer 112′ and the priority encoded de-multiplexer 113′. The other functions of the blocks of the integrated circuit 100′ are the same as in integrated circuit 100 and are not repeated herein for brevity.

Referring now to FIG. 1D, a diagram of the bussing scheme for the test bus 117′, the system bus 114′, and the debug bus 116′ of the integrated circuit 100′ is illustrated. Each of test bus 117′, the system bus 114′, and the debug bus 116′ includes a write data bus 170, a read data bus 171, an address bus 172, a write enable strobe WEN 173, and a read enable strobe REN 174. The address bus 172 includes A address lines. The write data bus 170 and read data bus 171 each include D data lines. In this case because write data bus 170 and read data bus 171 are provided, tri-statable drivers for driving data onto either data bus need not be used. Thus, the bussing schemes between FIGS. 1B and 1D are different.

The test system 101 can interface to the integrated circuit 100 and 100′ via a serial port interface 120 or a parallel port interface 122. The test system 101 includes a processor 150 which executes processor-readable code or software 151 in order to test and debug the integrated circuit 100 and 100′. The software 151 is flexible in that in and of itself it can provide multiple access to the different debug modes of the integrated circuit 100 and 100′. The software executed by the processor 150 includes test/debug software 152, a serial software driver 153, a host software driver 154, and an external software driver 156. The test/debug software 152 includes particular test/debug instructions for testing/debugging particular functional blocks and circuitry. Program memory for a DSP execution unit is one type of functional block that may be desirable to test for example. In this case, the test/debug software 152 includes the type of tests to perform on the program memory such as a “walking one” pattern. The driver software (serial software driver 153, host software driver 154, and direct access software driver 156) receives the type of tests and debugging from the test/debug software 152 and maps it into one or more of the three test/debug access methods as desired. The serial software driver 153 generates and receives serial data and test/debug signals over the serial port interface 120 of the serial I/O test port 108 of the integrated circuit 100 and 100′. The host software driver 154 generates, transmits and receives parallel data with the debug registers 106 over the parallel port interface 122 and through the host I/O port 110 to generate test/debug signals within the integrated circuit. The external software driver 156 also utilizes the parallel port interface 122 in order to directly communicate data and test/debug instruction signals over an internal debug bus 116 into the debug registers 106 bypassing the host I/O port 110. In any case, data, debug and test instructions can be signaled into the integrated circuit 100 and 100′ from the test system 101 in at least one of three ways to perform testing and debugging.

The serial I/O test port 108 in one embodiment is a Joint Test Action Group (JTAG) serial test port supporting the JTAG IEEE standard. In this case, the serial software driver 153 is a JTAG software driver.

The debug access modes are facilitated by the priority encoded multiplexer 112 and 112′ and the priority encoded demultiplexer 113 and 113′. The priority encoded multiplexer 112 and 112′ multiplexes a serial input 118 and two buses, a system bus 114 and a debug bus 116, together into one input into the debug registers 106. The priority encoded demultiplexer 113 and 113′ demultiplexes data output from the debug registers 106 into the system bus 114, the debug bus 116 or the serial signal output 117 respectively.

The selection between the multiplexer 112 and 112′ and the demultiplexer 113 and 113′ is controlled by a debug read/write signal which is a read/write strobe on the parallel port interface 122 or a serial input into the serial test port 108. The debug read/write signal determines whether the multiplexer 112 and 112′ or the demultiplexer 113 and 113′ is active. This is similar to selective enabling of tri-state I/O drivers to multiplex or demultiplex signals to/from a data bus. The output selected by the priority encoded multiplexer 112 and 112′ from its inputs is based on the priority encoding. The test mode 123 is input into the priority encoded multiplexer 112 and 112′ to influence the priority of selection. In one case with the test mode 123 being cleared, the priority encoded multiplexer 112 and 112′ first selects input activity from the serial input 118 if any, and then selects input activity from the system bus 114. This case ignores the debug bus 116 completely. In another case with the test mode 123 being set, the priority encoded multiplexer 112 and 112′ first selects input activity from the serial input 118, if any, then input activity from the system bus 114 is selected, and then input activity from the debug bus 116 is selected. The priority encoder can continue in this manner to receive further input information for the debug registers 106 by repeatedly looking for input activity in order depending upon what setting is chosen for the test mode.

In host debug access mode, test, data, instructions can be written into the debug registers 106 via the host I/O port 110 over the system bus 114 and through the multiplexer 112 and 112′. In host debug access mode, results can be read from the debug registers 106 through the demultiplexer 113 and 113′, over the system bus 114 and out from the host I/O port 110. The parallel port interface 122 includes an address bus, a data bus, and control lines to interface to both the host I/O port 110 and directly to the debug bus 116. The host software driver 154 views the debug registers as being I/O memory address mapped in addressing the different debug registers 106 over the address bus of the parallel port interface 122. Data is stored into or read out of selected debug registers via the data bus of the parallel port interface 122. By means of the host I/O port, the debug registers can be accessed in parallel by means of an I/O memory address mapped scheme. I/O memory address mapped means that the registers of the debug registers 106 are part of a memory map and can be accessed by using a memory address. The I/O memory address mapping allows reasonably fast accesses to the debug registers and provides readily software access.

In a serial access mode, the serial software driver 153 accesses the debug registers 106 serially over the serial port interface 120 through the serial I/O test port 108 and the multiplexer 112 and 112′ or the demultiplexer 113 and 113′. Serial data on the serial input 118, input into the integrated circuit 100 and 100′ for the debug registers 106, is converted into parallel data for loading therein in parallel. Parallel data, read out from the debug registers 106 of the integrated circuit 100 and 100′, is converted into serial data to be read out serially over the serial output 117 from a serial data pin. The serial port interface 120 for the embodiment of a JTAG serial I/O test port includes five pins through which five signals can be serially communicated between the test system 101 and the integrated circuit 100 and 100′. These pins are Test Clock (TCK), Test Mode Select (TMS), Test Data In (TDI), Test Data Out (TDO), and Test Reset (TRST). The serial I/O test port 108 supports boundary scan techniques of the functional blocks and circuitry as well as custom debug commands. The serial I/O test port 108 includes a Test Access Port (TAP) controller having a state machine to control the operations associated with the boundary scan cells. The serial I/O test port is a serial access to the on-chip debug capabilities of the integrated circuit including the debug registers 106. The serial I/O test port is not intrusive, can implement an IEEE standard, and utilizes a minimum number of pins, and facilitates a low frequency of operation.

In a direct access mode, the external software driver 156 accesses the debug registers 106 by means of direct access over the parallel port interface 122 onto the debug bus 116 and through the multiplexer 112 and 112′ or demultiplexer 113 and 113′, bypassing the host I/O port 110. On the integrated circuit 100 and 100′, host pads of the host I/O port 110 are shared with the debug bus 116 for the direct access mode. The host pads are bonding pads or contact points for wire bonding between the integrated circuit and an integrated circuit package. The direct access mode, which bypasses the host I/O port 110 and the system bus 114, can provide a higher speed of parallel access to facilitate more efficient testing and debugging of the integrated circuit 100 and 100′.

The test mode signal 123 is input over a pin of a packaged integrated circuit 100 and 100′ or a bonding pad/test pad of an unpackaged integrated circuit 100 and 100′ into the priority encoding of the priority encoded multiplexer 112 and 112′ and the priority encoded demultiplexer 113 and 113′ to indicate that direct access is desired around the host I/O port 110. Upon power up, the test mode signal 123 defaults to indicate to the priority encoding that direct access around the host I/O port 110 to the debug registers 106 is not desired.

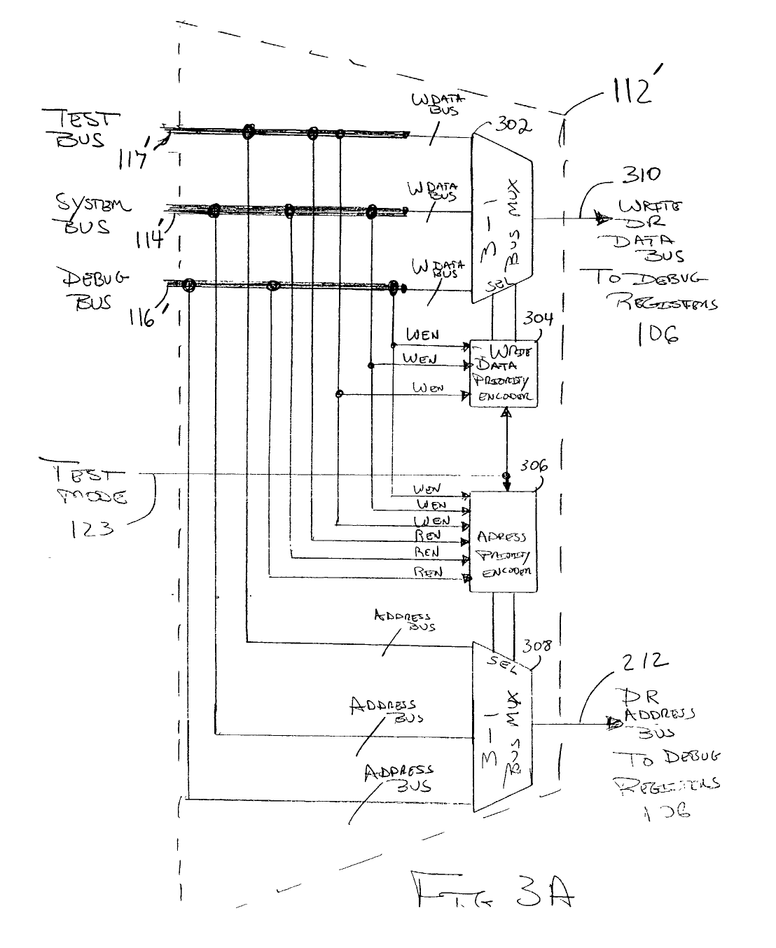

Referring now to FIGS. 2A and 2B, block diagrams of one exemplary embodiment of the priority encoded multiplexer 112 and one exemplary embodiment of a priority encoded demultiplexer 113 are illustrated respectively. The priority encoded multiplexer 112 and the priority encoded demultiplexer 113 correspond with the integrated circuit 100.

In FIG. 2A, the exemplary embodiment of the priority encoded multiplexer 112 includes a first three-to-one bus multiplexer 202, a write data priority encoder 204, a tri-state buffer 206, an address priority encoder 207, and a second three-to-one bus multiplexer 208 coupled together as shown. The first three-to-one bus multiplexer 202 multiplexes the data bus portion of each of the test bus 117, the system bus 114, and the debug bus 116 towards the single debug registers (DR) data bus 210. The second three-to-one bus multiplexer 208 multiplexes the address bus portion of each of the test bus 117, the system bus 114, and the debug bus 116 towards the single debug registers (DR) address bus 212.

The write data priority encoder 204 receives the control signals, R/W strobe and enable strobe, of each of the test bus 117, the system bus 114, and the debug bus 116 in order to detect a request to write information into the debug registers 106. The write data priority encoder 204 further receives the test mode signal 123 as an input to indicate whether or not the debug bus 116 is to be used and considered in the order of priority. The priority encoder 204 generates a pair of select signals for the three-to-one multiplexer 202 and the enable signal for the tri-state driver 206. The order of priority in which the select signals are generated give a highest priority to data from the test bus 117, next highest priority to data from the system bus 114, and if utilized, lowest priority to data from the debug bus 116.

In response to the pair of select signals from the write data priority encoder 204, the three-to-one multiplexer 202 selects the data bus portion of one of its input parallel buses (test bus 117, system bus 114, and debug bus 116) as the signals on its output. The output from the three-to-one multiplexer 202 couples into the input of the tri-state driver 206. The tri-state driver 206 selectively drives the debug registers (DR) data bus 210 with the output from the multiplexer 202 in response to the enable signal from the priority encoder 204. The debug registers (DR) data bus 210 for the integrated circuit 100 uses a tri-state bussing scheme and supports bidirectional data transfers between the debug registers 106.

The address priority encoder 207 receives the same signals as the write data priority encoder 204 including the control signals, R/W strobe and enable strobe, of each of the test bus 117, the system bus 114, and the debug bus 116 in order to detect a request to write information into the debug registers 106. The address priority encoder 207 further receives the test mode signal 123 as an input to indicate whether or not the debug bus 116 is to be used and considered in the order of priority. The priority encoder 207 generates a pair of select signals for the second three-to-one multiplexer 208. The order of priority in which the select signals are generated give a highest priority to addresses from the test bus 117, next highest priority to addresses from the system bus 114, and if utilized, lowest priority to addresses from the debug bus 116.

In response to the pair of select signals from the address priority encoder 207, the second three-to-one multiplexer 208 selects the address bus of one of its input parallel buses (test bus 117, system bus 114, and debug bus 116) as the signals on its output. The output from the second three-to-one multiplexer 208 couples to the debug registers (DR) address bus 212. The address of on the debug registers (DR) address bus 212 selects which register of the debug registers 106 into which data can be written into or read out from.

In FIG. 2B, the exemplary embodiment of the priority encoded demultiplexer 113 includes three tri-state buffers 221-223, and a read data priority encoder 226 coupled together as shown. The priority encoded demultiplexer 113 demultiplexes read data on the DR data bus 210 into the data bus portion of one of the test bus 117, system bus 114, and debug bus 116.

The read data priority encoder 226 receives the same signals as the write data priority encoder 204 and the address priority encoder 207 including the control signals, R/W strobe and enable strobe, of each of the test bus 117, the system bus 114, and the debug bus 116 in order to detect a request to read information from the debug registers 106. The read data priority encoder 226 further receives the test mode signal 123 as an input to indicate whether or not the debug bus 116 is to be used and considered in the order of priority.

The read data priority encoder 226 disables or enables the tristate drivers 221-223 in response to the priority of the busses and the received control signals. Data output from the tristate drivers 221-223 is merged into the data portion of the respective test bus 117, system bus 114 and the debug bus 116. The read data priority encoder 226 generates three enable signals, one for each of the tri-state drivers 221-223. The priority encoder 204 in FIG. 2A can be used to generate an address on the address bus 211 to the debug registers 106 to select a register from which data is to be read.

In response to an enable signal from the priority encoder 226, one of the three tri-state drivers 221-223 drives the respective bus coupled to its output. In this manner, data from the DR data bus 210 can be driven onto one of the three outputs (test bus 117, system bus 114, and debug bus 116) of the priority encoded demultiplexer 113.

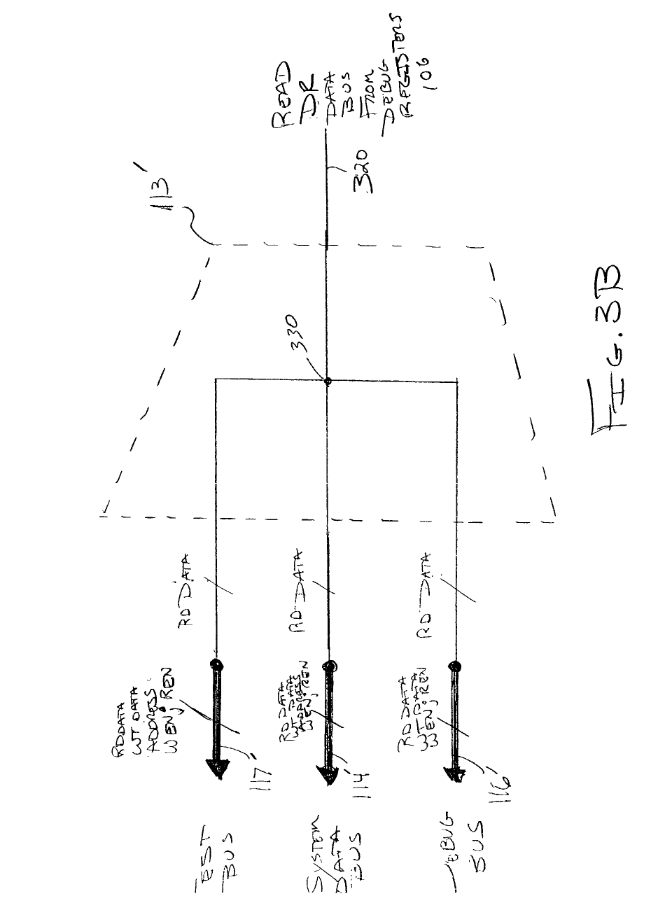

FIGS. 3A and 3B are respective block diagrams of another exemplary embodiment of the priority encoded multiplexer 112′ and the priority encoded demultiplexer 113′, respectively. The priority encoded multiplexer 112′ and the priority encoded demultiplexer 113′ correspond with the integrated circuit 100′.

In FIG. 3A, the exemplary embodiment of the priority encoded multiplexer 112′ includes a first three-to-one bus multiplexer 302, a write data priority encoder 304, an address priority encoder 306, and a second three-to-one bus multiplexer 308 coupled together as shown. The first three-to-one bus multiplexer 302 multiplexes the write data bus portion of each of the test bus 117′, the system bus 114′, and the debug bus 116′ towards the single write debug registers (DR) data bus 310. The second three-to-one bus multiplexer 308 multiplexes the address bus portion of each of the test bus 117′, the system bus 114′, and the debug bus 116′ towards the single debug registers (DR) address bus 212.

The write data priority encoder 304 receives the control signal, write enable strobe, of each of the test bus 117′, the system bus 114′, and the debug bus 116′ in order to detect a request to write information into the debug registers 106. The write data priority encoder 304 further receives the test mode signal 123 as an input to indicate whether or not the debug bus 116′ is to be used and considered in the order of priority. The write data priority encoder 304 generates a pair of select signals for the three-to-one multiplexer 302. The order of priority in which the select signals are generated give a highest priority to data on the test bus 117′, next highest priority to data from the system bus 114′, and if utilized, lowest priority to data from the debug bus 116′.

In response to the pair of select signals from the write data priority encoder 304, the three-to-one multiplexer 202 selects the data bus of one of its input parallel buses (test bus 117, system bus 114, and debug bus 116) as the signals on its output. The output from the three-to-one multiplexer 202 couples onto the write DR data bus 310 to the debug registers 106. The write debug registers (DR) data bus 310 is the write data bus portion previously discussed in the bussing scheme illustrated in FIG. 1D.

The address priority encoder 306 receives the control signals, read enable strobe REN and write enable strobe WEN, of each of the test bus 117′, the system bus 114′, and the debug bus 116′ in order to generate addresses according for registers in the debug registers 106. The address priority encoder 306 further receives the test mode signal 123 as an input to indicate whether or not the debug bus 116′ is to be used and considered in the order of priority. The priority encoder 306 generates a pair of select signals for the second three-to-one multiplexer 308. The order of priority in which the select signals are generated give a highest priority to addresses from the test bus 117′, next highest priority to addresses from the system bus 114′, and if utilized, lowest priority to addresses from the debug bus 116′.

In response to the pair of select signals from the address priority encoder 306, the second three-to-one multiplexer 308 selects the address bus of one of its input parallel buses (test bus 117′, system bus 114′, and debug bus 116′) as the signals on its output. The output from the second three-to-one multiplexer 308 couples to the debug registers (DR) address bus 212. The address of on the debug registers (DR) address bus 212 selects which register of the debug registers 106 into which data can be written into or read out from.

In FIG. 2B, the exemplary embodiment of the priority encoded demultiplexer 113′ is illustrated. The priority encoded demultiplexer 113′ in this case simply fans out the read debug registers (DR) data bus 320 from the debug registers into the read data bus portions of each of the test bus 117′, the system bus 114′, and the debug bus 116′ at node 330. Each of the read data bus portions is then merged into the respective test bus 117′, the system bus 114′, and the debug bus 116′. Whichever desired access will listen to their respective read data bus portion to read the information on the read debug registers (DR) data bus 320.

The three means of access into the debug registers 106 and controlling the debug of the integrated circuit 100 and 100′ disclosed herein, have various levels of intrusiveness. That is, they affect the normal function and operation of the integrated circuit at different levels, disabling the normal functionality of the integrated circuit 100 and 100′.

Debugging via the serial I/O test port 108 is non-intrusive. That is, the serial I/O test port in and of itself is a test port. It functions normally when being used to perform testing and debugging of the integrated circuit 100 and 100′, including when accessing the debug registers 106.

Accessing the on-chip debugging by means of the host I/O port 110 or over the system bus 114 is semi-intrusive. Anything having access to the system bus 114 can write into the debug registers 110 including the one or more execution units 102A-102N. This includes the access to the debug registers 106 by way of the host software driver 154, the parallel port interface 122, and the host I/O port 110. That is, the host I/O port 110 or the system bus 114 is utilized in order to perform debug in a semi-intrusive means. Thus, normal system access of the parallel port interface 122, the host I/O port 110, and the system bus 114 is momentarily unavailable for normal operations when the on chip debug capability including the debug registers 106 are accessed. Access to the on-chip debug capabilities by the host I/O port 110 only limits its normal bandwidth. When debug access is not being asserted, normal system access through the host I/O port 110 is available.

Direct access by means of the external software driver 156 over the parallel port interface 122 through the multiplexer 112 into the debug registers 106 is the most intrusive of these three means. In order to directly access the debug registers 106 via the parallel port interface 122, the host I/O port 110 is disabled and is unable to function normally. This is the reason why direct access is fully intrusive. Disabling the host I/O port 110 makes the direct access method the most intrusive option of the three debug methods disclosed. The integrated circuit 100 and 100′ in the case of direct access, can not fully function while being debugged, as it would, if it were not in a debug mode.

The serial access port 120, while being the least intrusive mechanism of performing debugging, typically requires a greater amount of time to perform debug. While the host I/O port 110 access to debug registers 106 is somewhat intrusive, it provides a quicker means of debugging because of the capability of writing and reading data in parallel. The direct access means disables the host I/O port, routes directly around it onto the debug bus 116 and into the debug registers 106 via the multiplexer 112 or demultiplexer 113. While the direct access is the most intrusive, it is also the quickest way to reduce the debug time because it can directly access the debug registers 106 and control the debug controller 104. These three means of debugging trade off the level of intrusiveness for the level of expediency in debugging.

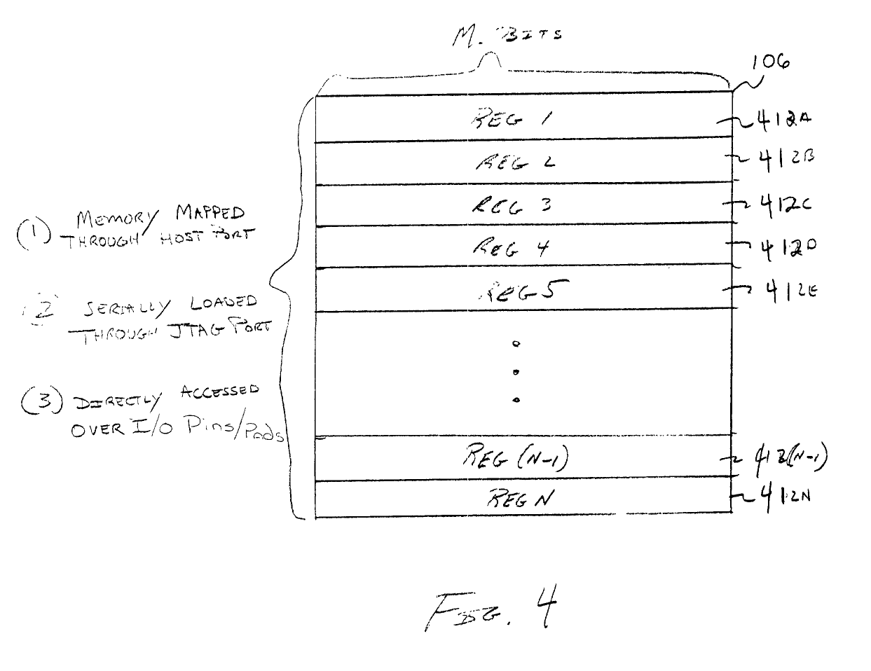

Referring now to FIG. 4, debug registers 106 are illustrated. The debug registers 106 includes n registers labeled register 1 412A through register N 412N. Each of the n registers 412A through 412N is m bits wide. In one embodiment, m is 32, such that each register is 32 bits wide. The debug features provided by the debug registers 106 include 1) break of execution; 2) inject commands; 3) single step; 4) reset; 5) break at address; and 6) PRAM. Each of these debug commands can be encoded into data bits and stored in the debug registers 106.

Access to the debug registers 106 is provided in three ways in the invention. Each of the n registers in one method is I/O memory addressed mapped through the host I/O port 110. In another method, each of the n registers is serially loaded in sequence through the serial I/O test port 108. In the third method, access to the n registers is direct by means of the address and data pins/pads at the parallel port interface 122 bypassing the host I/O port 110 directly into the debug registers 106. As previously mentioned, by loading the n registers within the debug registers 106 appropriately, the various commands in control of debugging the integrated circuit 100 and 100′ can be obtained. After writing to the debug registers 106 to complete the particular test/debug operation, the debug mode is automatically entered. Results of a debug/test command can be stored into one or more of the debug registers 106 which can in turn be read out from the integrated circuit by one of the three access methods.

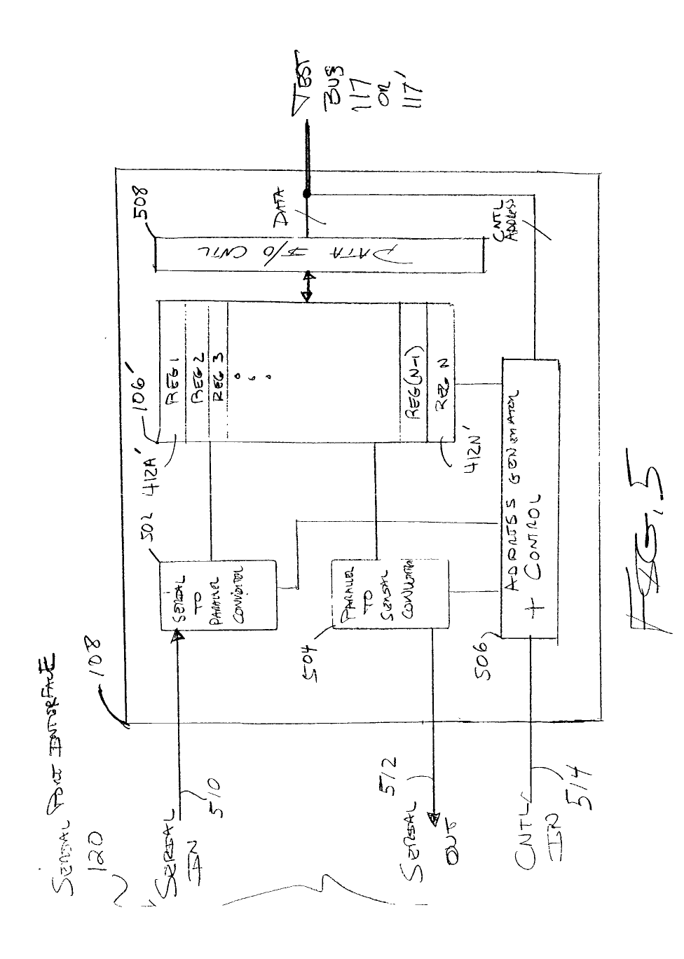

Referring now to FIG. 5, an exemplary embodiment of the serial test port 108 is illustrated. The serial test port 108 receives a serial input 510, a serial output 512 and one or more control inputs (CNTL IN) 514 as part of the serial port interface 120. The serial test port 108 interfaces to the test bus 117 or 117′ inside the integrated circuit to communicate through to the debug registers 106. The serial test port 108 includes a serial to parallel converter 502, a parallel to serial converter 504, an address generator/controller 506, a data I/O controller 508 and mirrored debug registers 106′. The mirrored debug registers 106′ includes N debug registers 412A′-412N′ that mirror the data that is to be stored into the debug registers 106 when being accessed by the serial test port 108. The test data and debug commands are first input into the mirrored debug registers 106′ via the serial port. Then, the data bits stored in the mirrored debug registers 106′ is then transferred to the debug registers 106 over the test bus 117 or 117′. In either case, the data I/O controller 508 can be designed to interface to either of the test bus 117 or the test bus 117′.

The serial to parallel converter 502 receives information serially on the serial input 510 and converts it into parallel data for storage into the mirrored debug registers 106′ in a write operation. The parallel to serial converter 504 receives parallel data from the mirrored debug registers 106′ during a read operation and converts it into serial information on the serial output 512.

The address generator/controller 506 receives the control input 514 of the serial port interface 120 and can control the serial to parallel converter 502, the parallel to serial converter 504, the data I/O controller 508 and the mirrored debug registers 106′ accordingly for information to be communicated through the serial test port 108. Additionally, the address generator/controller 506 generates addresses onto the address bus portion of the test bus 117 or 117′ and respective control signals for each test bus 117 or 117′ as the case may be.

The data I/O controller 508 couples to the data bus portion of the test bus 117 or the read data bus and the write data bus portions of the test bus 117′. Information is transferred between the mirrored debug registers 106′ and the data portion(s) of the test bus 117 or 117′ through the data I/O controller 508.

In the case that the serial test port 108 is a JTAG port, the serial input 510 is test data in (TDI) and the serial output 510 is the test data out (TDO) of the JTAG interface.

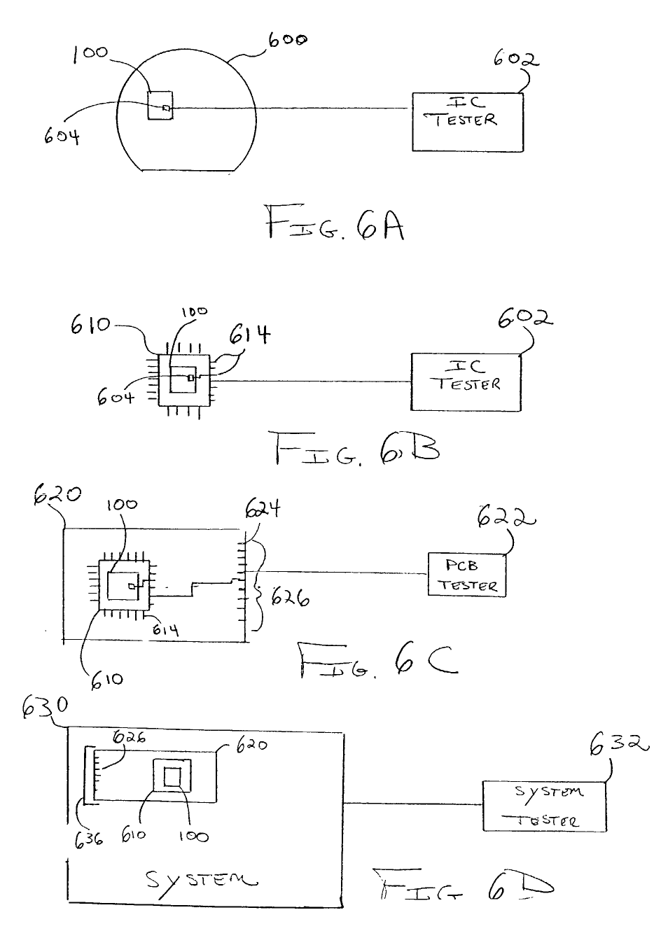

Referring now to FIGS. 6A through 6D, various methods of testing/debugging the integrated circuit 100 and 100′ are illustrated. In FIG. 6A, integrated circuit 100 and 100′ includes a plurality of pads 604 provided for testing and for wire-bonding out to pins. In FIG. 6A the integrated circuit 100 and 100′ is part of a wafer 600 that is an undergoing wafer testing by the IC tester 602. The IC tester 602 couples to a wafer prober which connects to the pads 604 of the integrated circuit 100 and 100′. The wafer prober moves from integrated circuit to integrated circuit on the wafer to determine if they pass or fail testing.

Referring now to FIG. 6B, the integrated circuit 100 and 100′ is packaged into an integrated circuit package 610. Each of the bond pads 604 of the integrated circuit 100 and 100′ are wire bonded to pins 614 of the integrated circuit 610. The IC tester 602 performs testing of the packaged part 610 by means of a packaged handler or a packaged part test head. The IC tester 602 can access the debug mode in any of the three ways previously described. Direct access to debug and test of the integrated circuit can speed the debug process of program code, circuitry, functional blocks and execution units.

Referring now to FIG. 6C, the integrated circuit 100 and 100′ in the package 610 is coupled to a printed circuit board (PCB) 620. The printed circuit board 620 is tested by means of a printed circuit board (PCB) tester 622 which couples to the pins/traces 624 of an edge connector 626. The pins/traces 624 of the printed circuit board 620 couple to the pins 614 of the integrated circuit package 610. In this manner, the PCB tester 622 couples through pins/traces 624 and pins 614 to the bond pads 604 of the integrated circuit device. The printed circuit board tester 622 can access the debug registers 106 in any of the three ways previously described to control the debug controller 104 and the testing and debugging of the integrated circuit 100 and 100′ including program code, circuitry, and functional blocks therein.

Referring now to FIG. 6D, the integrated circuit 100 and 100′ is found within a system 630. The system 630 is tested by a system tester 632. The printed circuit board 620 has its edge connector 626 coupled into a connector 636 of the system 630. In this manner, the PCB tester 622 couples. The system tester 632 couples through a system bus coupled to the connector 636, the pins/traces 624 of the edge connector 626, the pins 614 and the bond pads 604 of the integrated circuit device 100 and 100′. The system tester 632 can use the three methods of debug access to the debug registers 106 for controlling the debug controller 104 in debugging and testing software code and hardware of the integrated circuit 100 and 100′.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. The invention may be implemented in hardware, software, firmware or a combination thereof and utilized in systems, subsystems, components or sub-components thereof. When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. In any case, the invention should not be construed as limited by such embodiments, but rather construed according to the claims that follow below.

What is claimed is:

1. A method comprising:
selecting one or more of three access methods provided in an integrated circuit to debug program code and/or circuitry contained therein, the three access methods including,
a serial debug access through a serial I/O test port of the integrated circuit,
a parallel I/O mapped debug access through a host I/O port of the integrated circuit, and
a parallel direct debug access through I/O pads of the integrated circuit.

2. The method of claim 1, wherein
the selecting of the one or more three access methods includes
setting a test mode input on an I/O pad of the integrated circuit.

3. The method of claim 1, wherein
the parallel direct debug access is through host I/O pads around circuitry of the host I/O port.

4. The method of claim 1, further comprising:
debugging the integrated circuit using test/debug instructions and data.

5. The method of claim 4, wherein
the debugging of the integrated circuit includes
setting a plurality of registers in the integrated circuit to control the debugging of the integrated circuit.

6. The method of claim 5, wherein
the plurality of registers in the integrated circuit control a debug controller in the integrated circuit to control the debugging.

7. The method of claim 5, wherein
the serial debug access method is selected and the setting of the plurality of registers is serially performed.

8. The method of claim 5, wherein
the parallel I/O mapped debug access method is selected and the setting of the plurality of registers is performed in parallel by memory map addressing of the plurality of registers and the data therein.

9. The method of claim 5, wherein
the parallel direct debug access method is selected and the setting of the plurality of registers is performed in parallel directly addressing each of the plurality of registers and the data therein.

10. The method of claim 2, wherein
the setting of the test mode input controls a select input control of a multiplexer in the integrated circuit to select between parallel I/O mapped debug access and parallel direct debug access to debug the integrated circuit.

11. An integrated circuit comprising:
debug registers to control on-chip testing and debugging of the integrated circuit;
a serial test port to access the debug registers serially;
a host I/O port to access the debug registers in parallel using I/O memory mapped access; and
I/O pads to access the debug registers in parallel using direct access.

12. The integrated circuit of claim 11, further comprising:
a multiplexer to select between loading the debug registers in parallel with the host I/O port and the I/O pads.

13. The integrated circuit of claim 12, wherein
the multiplexer is responsive to a test mode input of an I/O pad.

14. The integrated circuit of claim 11, further comprising:
a demultiplexer to select between reading information from the debug registers in parallel with the host I/O port and the I/O pads.

15. The integrated circuit of claim 14, wherein
the demultiplexer is responsive to a test mode input of an I/O pad.

16. The integrated circuit of claim 11, further comprising:
one or more digital signal processing units to test and debug.

17. The integrated circuit of claim 11, further comprising:
one or more functional blocks having circuitry to test and debug.

18. The integrated circuit of claim 11, further comprising:
one or more memories having program code to test and debug.

19. The integrated circuit of claim 11, further comprising:
a global memory having program code to test and debug.

20. The integrated circuit of claim 11, further comprising:
a debug controller coupled to the debug registers, the debug controller to test and debug circuitry within the integrated circuit in response to the information stored in the debug registers.

21. The integrated circuit of claim 20, wherein
the information stored in the debug registers is one or more debug instructions of the set of break execution, inject command, single step, reset, break at address, and PRAM.

22. A integrated circuit test system comprising:
an integrated circuit including,
debug registers to control on-chip testing and debugging of the integrated circuit,
a serial test port to load the debug registers serially,
a host I/O port to load the debug registers in parallel using I/O memory mapped access, and
I/O pads to load the debug registers in parallel using direct access; and
a tester including,
a processor readable storage medium, and
code recorded in the processor readable storage medium
to test and debug the integrated circuit,
to interface the tester to the serial test port of the integrated circuit to load the debug registers serially,
to interface the tester to the host I/O port of the integrated circuit to load the debug registers in parallel using I/O memory mapped access, and
to interface the tester to the I/O pads of the integrated circuit to load the debug registers in parallel using direct access.

23. The integrated circuit test system of claim 22, wherein
the processor readable storage medium is one or more of the set of magnetic storage medium, optical storage medium, or semiconductor storage medium.

24. The integrated circuit test system of claim 22, wherein the integrated circuit further includes
a multiplexer to select between loading the debug registers in parallel with the host I/O port and the I/O pads.

25. The integrated circuit test system of claim 24, wherein
the multiplexer is responsive to a test mode input of an I/O pad.

26. The integrated circuit test system of claim 22, wherein
the integrated circuit is a packaged integrated circuit and the tester is a packaged integrated circuit tester to test and debug the packaged integrated circuit.

27. The integrated circuit test system of claim 22, wherein
the integrated circuit is packaged and coupled to a printed circuit board and the tester is a printed circuit board tester to test and debug the printed circuit board including the integrated circuit.

28. The integrated circuit test system of claim 22, wherein
the integrated circuit is packaged and coupled to a printed circuit board which is inserted into a system and the tester is a system tester to test and debug the system and the printed circuit board including the integrated circuit.
